(19) United States
(12) Patent Application Publication
(10) Pub. No.: US 2023/0359792 A1
(43) Pub. Date: Nov. 9, 2023

(54) METHOD AND SYSTEM FOR HIGH-SPEED TRANSIENT THERMAL SIMULATION OF ELECTRONIC DEVICE

(71) Applicant: SHANDONG UNIVERSITY, Qingdao (CN)

(72) Inventors: Jiayue YANG, Qingdao (CN); Jian WANG, Qingdao (CN); Zhiwei FU, Qingdao (CN); Chao YANG, Qingdao (CN); Dezhi MA, Qingdao (CN)

(73) Assignee: SHANDONG UNIVERSITY, Qingdao (CN)

(21) Appl. No.: 17/890,555

(22) Filed: Aug. 18, 2022

(30) Foreign Application Priority Data
May 9, 2022 (CN) 2022104956803

(51) Int. Cl. G06F 30/28

(52) U.S. Cl. CPC G06F 30/28

(57) ABSTRACT

A method and system for high-speed transient thermal simulation of an electronic device and belongs to the technical field of high-speed transient thermal simulation of electronic devices. According to acquired parameter data of the electronic device, a dynamic weak balance relationship among heat generation amount, internal energy increment and heat dissipation amount of the electronic device is calculated to obtain a functional relationship between operating temperature and time of the electronic device; a trough temperature value of a transient temperature curve of electronic device in weak balance state is obtained by limit solving algorithm; an initial temperature is set in a manner of loading a fixed-temperature heat source, and simulating calculation is performed for a first preset number of cycles to obtain an initial temperature field; and a high-speed transient temperature change of the electronic device is obtained by the operation of a second preset number of pulse stress cycles.

### TECHNICAL FIELD

The present invention relates to the technical field of high-speed transient thermal simulation of electronic devices, and particularly relates to a method and system for high-speed transient thermal simulation of an electronic device.

### BACKGROUND

The description in this section merely provides background information related to the present invention, and does not necessarily constitute the prior art.

As the power density of electronic devices continues to increase, the operating temperature inside the device rises sharply, which not only changes the electrical characteristics of the device, but also directly reduces the service life of the device. Therefore, data about the operating temperature is an important technical indicator for evaluating the thermal design level of electronic devices. At this stage, with the popularization and application of the 5G communication technology, the demand for electronic devices with high power density is also increasing. Moreover, the devices often need to work under high-frequency pulse stress conditions, resulting in severe transient changes in the operating temperature of the devices. However, when the working pulse period of the electronic device reaches the microsecond/nanosecond level, the temperature simulation process thereof under dynamic balance will require calculation of more than ten million cycles. Traditional simulation methods and computer performance cannot meet such requirements.

The inventor found that in the existing technical solution, two methods are generally adopted to perform high-speed transient thermal simulation of the electronic devices.

According to the first method, reference is made to the traditional simulation process to establish a geometric model in the simulation software, set and import the corresponding material thermal performance parameters and pulse period conditions, then perform grid division, perform solving and calculating, and finally obtain the temperature field of the device after dynamic balance after lots of periodic iteration. This method has the following disadvantages: when the working pulse period of the electronic device reaches the microsecond/nanosecond level, operation of over ten million cycles is needed in the simulation process, and the time cost is huge; the operation of over ten million cycles is extremely high in demand for the performance of the computer, and ordinary computer systems cannot meet such a requirement.

The second method is based on the traditional simulation process. By increasing the simulation time step continuously and ignoring the microsecond/nanosecond-level transient temperature change of the device after dynamic balance, then the temperature field after the device temperature is stabilized is obtained by simulation (as shown in FIG. 1). This method has the following disadvantages: the simulation time step is increased, the simulation conditions of the device do not match the actual working conditions; the microsecond/nanosecond-level transient temperature change of the device after dynamic balance is ignored, and the transient temperature change characteristics of the device cannot be obtained.

### SUMMARY

In order to solve the deficiencies in the prior art, the present invention provides a method and system for high-speed transient thermal simulation of an electronic device, which not only can effectively acquire a high-speed transient temperature change of the electronic device, but also avoids an operation process of over ten million cycles before dynamic temperature balance, thus greatly reducing the simulation time and operation cost.

In order to realize the above objectives, the present invention adopts the technical solution as follows:

In a first aspect, the present invention provides a method for high-speed transient thermal simulation of an electronic device.

The method for high-speed transient thermal simulation of the electronic device includes the following process:
acquiring parameter data of the electronic device;
according to the acquired parameter data, calculating a dynamic weak balance relationship among a heat generation amount, an internal energy increment and a heat dissipation amount of the electronic device so as to obtain a functional relationship between an operating temperature and time of the electronic device;
based on the obtained functional relationship between the operating temperature and time of the electronic device, obtaining a trough temperature value of a transient temperature curve of the electronic device in a weak balance state by a limit solving algorithm;
based on the trough temperature value, setting an initial temperature in a manner of loading a fixed-temperature heat source, and performing simulating calculation for a first preset number of cycles to obtain an initial temperature field; and
based on the initial temperature field, obtaining a high-speed transient temperature change of the electronic device by the operation of a second preset number of pulse stress cycles.

As an alternative implementation mode, the functional relationship between the temperature T and the time t of the electronic device is as follows:

$$T = {T}_{0} + \frac{{Σ}_{i} {P}_{i} {D}_{i} t}{{Σ}_{i} {C}_{i} {ρ}_{i} {V}_{i} + {Σ}_{i} {h}_{i} {A}_{i} t}$$

where Pᵢ is power of each element, Dᵢ is a duty ratio of a power pulse period of each element, Cᵢ is a constant-pressure specific heat capacity of each element, ρᵢ, is a density of each element, and Vᵢ is a volume of each element; and T is a temperature of the device at time t, T₀ is an ambient temperature, hᵢ is a convective heat exchange coefficient between each element and air, and Aᵢ is a convective heat exchange area between each element and air.

As a further definition, the trough temperature value is as follows:

$$\overline{T} = {T}_{0} + {lim}_{t \to ∞} \frac{{Σ}_{i} {P}_{i} {D}_{i} t}{{Σ}_{i} {C}_{i} {ρ}_{i} {V}_{i} + {Σ}_{i} {h}_{i} {A}_{i} t} = {T}_{0} + \frac{{Σ}_{i} {P}_{i} {D}_{i}}{{Σ}_{i} {h}_{i} {A}_{i}}$$

As an alternative implementation mode, before setting an initial temperature in a manner of loading a fixed-temperature heat source, a physical structure model of the device is constructed and relevant material parameters are set, the relevant material parameters including: density, constant-pressure specific heat capacity and thermal conductivity.

As an alternative implementation mode, the dynamic weak balance relationship among the heat generation amount, the internal energy increment, and the heat dissipation amount of the electronic device is as follows:

Q_{heat generation amount}=U_{internal energy}+H_{heat dissipation amount}
where Q_{heat generation amount} is total Joule heat generated by each element in the device, U_{internal energy} is an internal energy change amount of each element in the device, and H_{heat dissipation amount} is a total convective heat exchange amount between each element and air.

As a further definition, Q_{heat generation amount}=ΣᵢPᵢDᵢt
where Pᵢ is the power of each element, and Dᵢ is the duty ratio of the power pulse period of each element.

As a further definition, U_{internal energy}=ΣᵢCᵢρᵢVᵢ(T−T₀)
where Cᵢ is the constant-pressure specific heat capacity of each element, ρᵢ is the density of each element, Vᵢ is the volume of each element, T is the temperature of the device at time t, and T₀ is the ambient temperature.

As a further definition, H_{heat dissipation amount}=ΣᵢhᵢAᵢ(T−T₀)t
where hᵢ is the convective heat exchange coefficient between each element and air, Aᵢ is the convective heat exchange area between each element and air, T is the temperature of the device at time t, and T₀ is the ambient temperature.

In a second aspect, the present invention provides a system for high-speed transient thermal simulation of an electronic device.

The system for high-speed transient thermal simulation of the electronic device, includes:
a data acquiring module, configured to acquire parameter data of the electronic device;
a temperature and time relationship acquiring module, configured to, according to the acquired parameter data, calculate a dynamic weak balance relationship among a heat generation amount, an internal energy increment and a heat dissipation amount of the electronic device so as to obtain a functional relationship between an operating temperature and time of the electronic device;
a trough temperature acquiring module, configured to, based on the obtained functional relationship between the operating temperature and time of the electronic device, obtain a trough temperature value of a transient temperature curve of the electronic device in a weak balance state by a limit solving algorithm;
an initial temperature field generating module, configured to, based on the trough temperature value, set an initial temperature in a manner of loading a fixed-temperature heat source, and performing simulating calculation for a first preset number of cycles to obtain an initial temperature field; and
a high-speed transient temperature change simulation result generating module, configured to, based on the initial temperature field, obtain a high-speed transient temperature change of the electronic device by the operation of a second preset number of pulse stress cycles.

As an alternative implementation mode, the trough temperature value is as follows:

$$\overline{T} = {T}_{0} + {lim}_{t \to ∞} \frac{{Σ}_{i} {P}_{i} {D}_{í} t}{{Σ}_{i} {C}_{i} {ρ}_{i} {V}_{i} + {Σ}_{i} {h}_{i} {A}_{i} t} = {T}_{0} + \frac{{Σ}_{i} {P}_{ι} {D}_{i}}{{Σ}_{i} {h}_{i} {A}_{i}}$$

where Pᵢ is power of each element, Dᵢ is a duty ratio of a power pulse period of each element, Cᵢ is a constant-pressure specific heat capacity of each element, ρᵢ is a density of each element, and Vᵢ is a volume of each element; and T is a temperature of the device at time t, T₀ is an ambient temperature, hᵢ is a convective heat exchange coefficient between each element and air, and Aᵢ is a convective heat exchange area between each element and air.

Compared with the prior art, the present invention has the following beneficial effects:

1. According to the method and system for high-speed transient thermal simulation of the electronic device in the present invention, the functional relationship between the operating temperature and time of the electronic device is acquired based on the energy conservation law. The initial temperature of a model is set in the manner of loading the fixed-temperature heat source, and then the high-speed transient temperature change of the electronic device is acquired by using the operation of a few of pulse stress cycles. Not only is the high-speed transient temperature change of the electronic device effectively acquired, but also the operation process of over ten million cycles before dynamic temperature balance is avoided, thus greatly reducing the simulation time and operation cost.

2. The method and system for high-speed transient thermal simulation of the electronic device in the present invention will be effectively applied to pre-thermal simulation and thermal design work for transient operation of the device, with great economic and social benefits.

The advantages of the additional aspects of the present invention will be set forth in part in the description below, parts of which will become apparent from the description below, or will be understood by the practice of the present invention.

### BRIEF DESCRIPTION OF THE DRAWINGS

The accompanying drawings constituting a part of the present invention are used to provide a further understanding of the present invention. The exemplary embodiments of the present invention and descriptions thereof are used to explain the present invention, and do not constitute an improper limitation of the present invention.

FIG. 1 is a schematic diagram of a temperature change curve provided in the background art without taking microsecond-level fluctuations into account.

FIG. 2 is a schematic flow chart of a method for high-speed transient thermal simulation of an electronic device provided in Embodiment 1 of the present invention.

FIG. 3 is a schematic diagram of a function curve between temperature T and time t provided in Embodiment 1 of the present invention.

FIG. 4 is an effect diagram of a device simulation model provided in Embodiment 1 of the present invention.

FIG. 5 is a schematic diagram of mode setting of a fixed-temperature heat source provided in Embodiment 1 of the present invention.

FIG. 6 is a schematic diagram of power pulse period setting of a silicon element provided in Embodiment 1 of the present invention.

FIG. 7 is a schematic diagram of transient simulation condition setting provided in Embodiment 1 of the present invention.

FIG. 8 is a schematic diagram of a temperature change curve of monitoring points of a copper element and a silicon element provided in Embodiment 1 of the present invention.

FIG. 9 is an X-direction temperature cloud chart at 58 s provided in Embodiment 1 of the present invention.

FIG. 10 is a Y-direction temperature cloud chart at 58.36 s provided in Embodiment 1 of the present invention.

FIG. 11 is a Z-direction temperature cloud chart at 59 s provided in Embodiment 1 of the present invention.

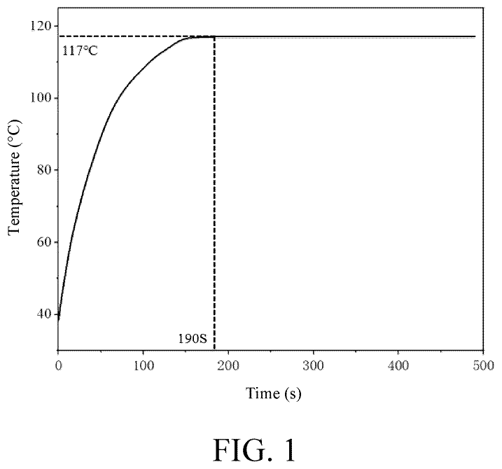

### DETAILED DESCRIPTION

The present invention is further described below with reference to the accompanying drawings and the embodiments.

It should be noted that, the following detailed descriptions are all exemplary, and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to include the plural form, unless the context clearly indicates otherwise. In addition, it should be further understood that terms “comprise” and/or “include” used in this specification indicate that there are features, steps, operations, devices, components, and/or combinations thereof.

The embodiments in the present invention and features in the embodiments may be mutually combined in a case that no conflict occurs.

### Embodiment 1

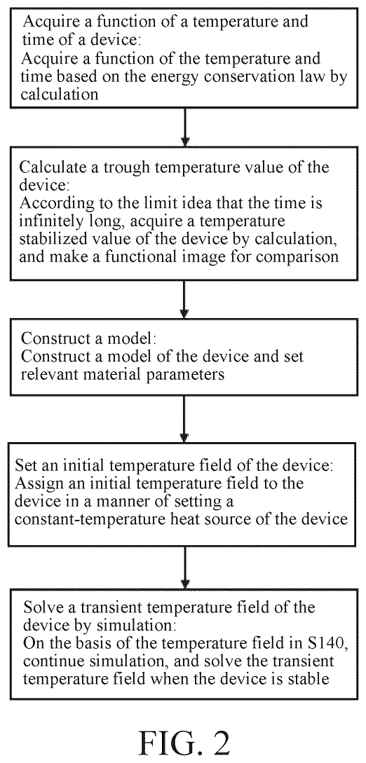

Embodiment 1 of the present invention provides a method for high-speed transient thermal simulation of an electronic device. As shown in FIG. 2, a dynamic weak balance relationship among a heat generation amount, an internal energy increment and a heat dissipation amount of the electronic device is calculated based on the energy conservation law so as to acquire the functional relationship between an operating temperature and time of the electronic device is acquired. A trough temperature value of a transient temperature curve of the electronic device in a weak balance state is calculated by a limit solving algorithm. Finally, an initial temperature of a model is set in a manner of loading a fixed-temperature heat source, and then the high-speed transient temperature change of the electronic device is acquired by the operation of a few of pulse stress cycles. The present invention not only can effectively acquire the high-speed transient temperature change of the electronic device, but also avoids the operation process of over ten million cycles before dynamic temperature balance, thus greatly reducing the simulation time and operation cost.

Specifically, the method includes the following process:

### S1: Acquire a Function of a Device Temperature Over Time

In order to obtain the functional relationship of the temperature and time of the electronic device based on the energy conservation law, the specific steps are as follows:

S1.1: According to the energy conservation law, the total generated heat of the electronic device is totally used for the increment of its internal energy and the heat dissipation to the outside. The heat dissipation to the outside is mainly characterized by the convective heat exchange with the surrounding air. The heat radiation energy is negligible. Therefore, the following can be obtained:

Q_{heat generation amount}=U_{internal energy}+H_{heat dissipation amount} (1)
where Q_{heat generation amount} is total Joule heat generated by each element in the device, U_{internal energy} is an internal energy change amount of each element in the device, and H_{heat dissipation amount} is a total convective heat exchange amount between each element and air.

S1.2: The cumulative amount of total heat generated by the electronic device at time t is as follows:

Q_{heat generation amount}=ΣᵢPᵢDᵢt (2)
where Q_{heat generation amount} is the total Joule heat generated by each element in the device, Pᵢ is the power of each element, and Dᵢ is the duty ratio of the power pulse period of each element.

S1.3: The cumulative increment in internal energy generated by the electronic device at time t is as follows:

U_{internal energy}=ΣᵢCᵢρᵢVᵢ(T−T₀) (3)
where U_{internal energy} is an internal energy change amount of each element in the device, Cᵢ is a constant-pressure specific heat capacity of each element, ρᵢ is a density of each element, Vᵢ is a volume of each element; and T is a temperature of the device at time t, and T₀ is an ambient temperature.

S1.4: A total amount of heat dissipated by the electronic device during convective heat exchange at time t is as follows:

H_{heat dissipation amount}=ΣᵢhᵢAᵢ(T−T₀)t (4)
where H_{heat dissipation amount} is a total convective heat exchange amount between each element and air, hᵢ is a convective heat exchange coefficient between each element and air, Aᵢ is a convective heat exchange area between each element and air, T is the temperature of the device at time t, and T₀ is the ambient temperature.

S1.5: The functional relationship between temperature T and time t of the electronic device is then obtained as follows:

$$T = {T}_{0} + \frac{{Σ}_{i} {P}_{i} {D}_{i} t}{{Σ}_{i} {C}_{i} {ρ}_{i} {V}_{i} + {Σ}_{i} {h}_{i} {A}_{i} t} \qquad ( 5 )$$

### S2: Calculate the Trough Temperature Value of the Device

In order to calculate the trough temperature value of the device, loading the initial temperature field of a simulation model has the following specific steps:

S2.1: According to the limit idea, when the time is infinitely long, the temperature value of the model is as follows:

$$\overline{T} = {T}_{0} + {lim}_{t \to ∞} \frac{{Σ}_{i} {P}_{i} {D}_{i} t}{{Σ}_{i} {C}_{i} {ρ}_{i} {V}_{i} + {Σ}_{i} {h}_{i} {A}_{i} t} = {T}_{0} + \frac{{Σ}_{i} {P}_{i} {D}_{i}}{{Σ}_{i} {h}_{i} {A}_{i}} \qquad ( 6 )$$

S2.2: A functional image of T(t) is made to further verify the trough temperature value of the device.

### S3: Calculate a High-Speed Transient Temperature Change

In order to complete the high-speed transient temperature change calculation of the device, the specific steps are as follows:

S3.1: A physical structure model of the device is constructed in simulation software, and relevant material parameters (density, constant-pressure specific heat capacity, thermal conductivity, etc.) are set.

S3.2: Then, in the manner of loading the fixed-temperature heat source, each element is set as a heat source which is a fixed-temperature heat source. The constant temperature is the trough temperature value calculated in S2.1. Simulating calculation is performed for 1-2 cycles so as to assign a temperature field to the model.

S3.3: Finally, taking the temperature field in S3.2 as the initial temperature field, the high-speed transient temperature change of the electronic device is then acquired by using the operation of a few of pulse power cycles.

Next, transient thermal simulation analysis is performed by the method described in this embodiment by using a model composed of a copper element and a silicon element.

### (1) Experimental Equipment

FloTHERM simulation software, copper element (100*100*10 mm), and silicon element (20*20*20 mm). The silicon element is a pulse power element, having a pulse period of 2 s and a duty ratio of 50%. Connection between copper and silicon is close, and heat conducting between copper and silicon is good. The ambient temperature is 35° C. The air flow rate is 0.2 m/s. Table 1 shows the physical parameters of each element.

TABLE 1
Physical Parameters of Each Element

| | Physical Parameters | | | | |
|---|---|---|---|---|---|
| | ρ | Cₚ | λ | h_{f} | P |
| Material | (kg/m³) | (J/kg · K) | (W/m · K) | (W/m² · K) | (W) |
| Copper block | 8930 | 385 | 385 | 4.9 | 0 |
| Silicon block | 2330 | 700 | 117.5 | 5 | 2 |

### (2) Experimental Procedures

### (2-1) Acquire a Function of the Device Temperature Over Time

1) The cumulative amount of total heat generated by the electronic device at time t is as follows:

$${Q}_{heat generation amount} = {\sum }_{i} {P}_{i} {D}_{i} t = {P}_{Si} {D}_{i} t + {P}_{Cu} {D}_{Si} t = 2 \times 50 \% \times t = t J$$

2) The cumulative increment in internal energy generated by the electronic device at time t is as follows:

$${U}_{internal energy} = {\sum }_{i} {C}_{i} {ρ}_{i} {V}_{i} ( T - {T}_{0} ) = {C}_{Cu} {ρ}_{Cu} {V}_{Cu} ( T - {T}_{0} ) + {C}_{Si} {ρ}_{Si} {V}_{Si} ( T - {T}_{0} ) = ( 385 \times 8930 \times 0 . {1}^{2} \times 0.01 + 700 \times 2330 \times 0.0 {2}^{3} ) ( T - {T}_{0} ) = 356.853 ( T - {T}_{0} )$$

3) The total amount of heat dissipated by the electronic device during convective heat exchange at time t is as follows:

$${H}_{heat dissipation amount} = {\sum }_{i} {h}_{i} {A}_{i} ( T - {T}_{0} ) t = ( {h}_{C u} {A}_{C u} + {h}_{S i} {A}_{S i} ) ( T - {T}_{0} ) \text{} t = [ 4.9 \times ( 0 . {1}^{2} \times 2 + 0.1 \times 0.01 \times 4 - 0.0 {2}^{2} ) + 5 \times 0.0 {2}^{2} \times 5 ] ( T - {T}_{0} ) t = ( 0.11564 + 0.01 ) ( T - {T}_{0} ) t = 0.12564 ( T - {T}_{0} ) t J$$

4) The functional relationship between temperature T and time t of the electronic device is then obtained as follows:

t=356.853(T−T₀)+0.12564(T−T₀)t

The following is obtained by summarization:

$$T = 35 + \frac{t}{0.1256 t + 356.853}$$

### (2-2) The Trough Temperature Value of the Device is Calculated.

1) The trough temperature value of the device is solved by a limit principle.

$$\overline{T} = 35 + {lim}_{t \to ∞} \frac{t}{0.1256 t + 356853} = 35 + 7.96 = 42.96 ° C .$$

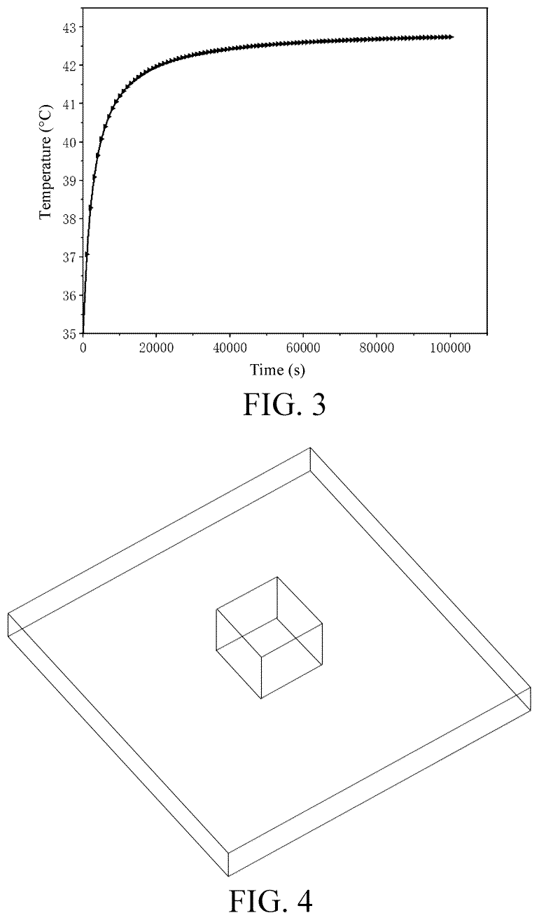

2) A functional image of T(t) is made, as shown in FIG. 3.

### (2-3) The Initial Temperature Field of the Device is Set.

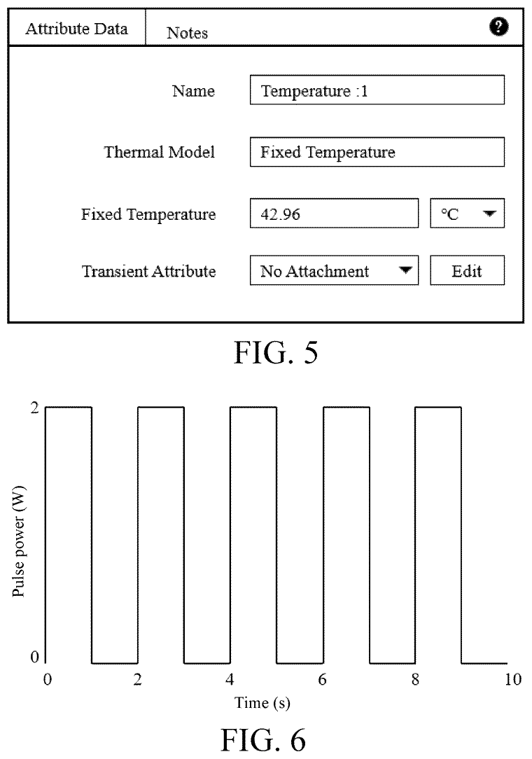

1) A simulation model is constructed in FloTHERM in combination with device parameters. Temperature monitoring points are respectively set at the geometric centers of the copper element and the silicon element, as shown in FIG. 4.
2) The Thermal Mode of each element of the model is set to the fixed-temperature heat source mode of Fixed Temperature. The temperature value of the fixed-temperature heat source is 42.96° C., as shown in FIG. 5.
3) The model is simulated for 2 s (several cycles) to obtain the initial temperature field.

### (2-4) The Power Pulse Period and Transient Simulation Conditions are Set.

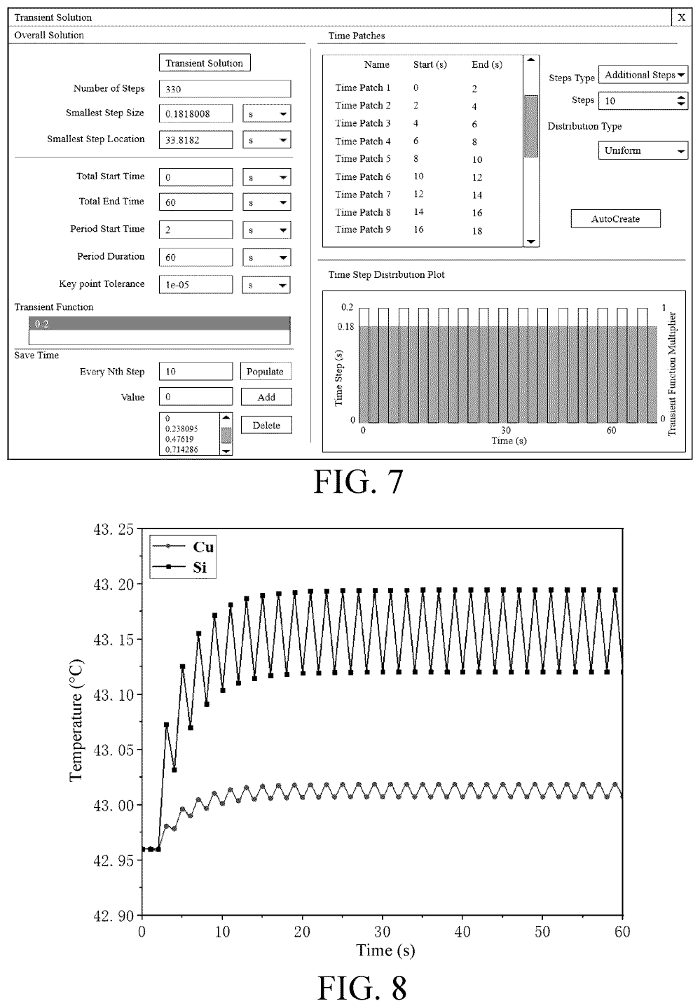

1) The copper element is changed to a Conduction mode with a power value of 0 W. The silicon element is also changed to a Conduction mode with a power value of 2 W. The power pulse period of the silicon element is set to 2 s, and the duty ratio is 50%, as shown in FIG. 6.
2) The transient simulation time is set to 60 s, a total of 30 cycles. The number of iteration steps per cycle is 10, and data storage points are set to 10, as shown in FIG. 7.

### (2-5) Model Simulation is Solved.

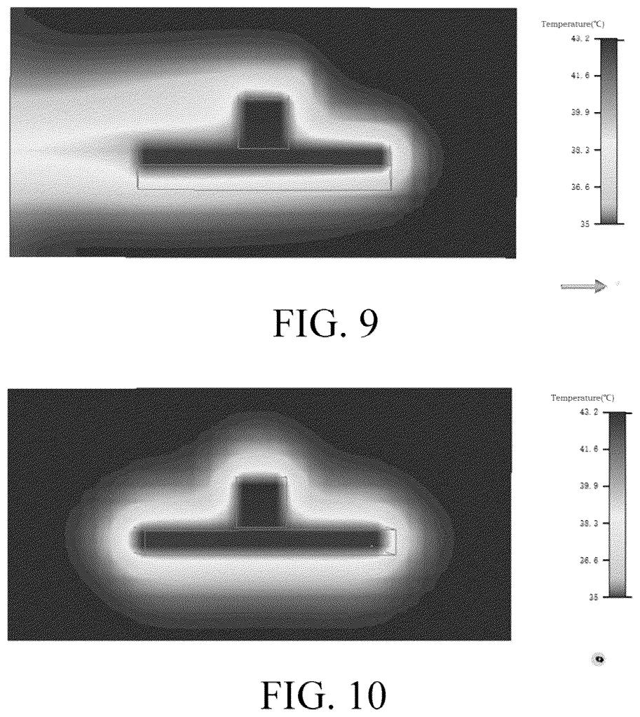

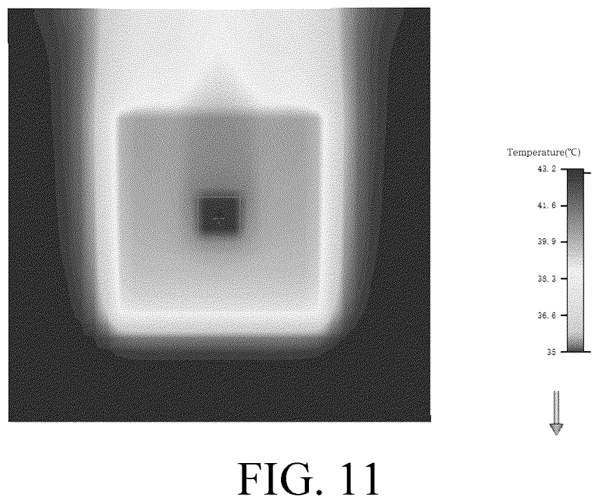

1) With the temperature field obtained in (2-3) as the initial temperature field to continue the simulation, the temperature of each monitoring point of the model rapidly reaches a stable state. At 60 s, the silicon element is at 43.1° C., and the copper element is at 43° C., as shown in FIG. 8.
2) The transient temperature cloud chart is obtained after the model temperature field is stabilized, as shown in FIG. 9, FIG. 10 and FIG. 11.

### Embodiment 2

Embodiment 2 of the present invention provides a system for high-speed transient thermal simulation of an electronic device, including:
a data acquiring module, configured to acquire parameter data of the electronic device;
a temperature and time relationship acquiring module, configured to, according to the acquired parameter data, calculate a dynamic weak balance relationship among a heat generation amount, an internal energy increment and a heat dissipation amount of the electronic device so as to obtain a functional relationship between an operating temperature and time of the electronic device;
a trough temperature acquiring module, configured to, based on the obtained functional relationship between the operating temperature and time of the electronic device, obtain a trough temperature value of a transient temperature curve of the electronic device in a weak balance state by a limit solving algorithm;
an initial temperature field generating module, configured to, based on the trough temperature value, set an initial temperature in a manner of loading a fixed-temperature heat source, and performing simulating calculation for a first preset number of cycles to obtain an initial temperature field; and
a high-speed transient temperature change simulation result generating module, configured to, based on the initial temperature field, obtain a high-speed transient temperature change of the electronic device by the operation of a second preset number of pulse stress cycles.

The operating method of the system is the same as that of the high-speed transient thermal simulation for the electronic device provided in Embodiment 1 and will not be described in detail here.

A person skilled in the art should understand that the embodiments of the present invention may be provided as a method, a system, or a computer program product. Therefore, the present invention uses a form of hardware embodiments, software embodiments, or embodiments combining hardware and software. Moreover, the present invention may use a form of a computer program product that is implemented on one or more computer-usable storage media (including but not limited to a disk memory, a compact disc read-only memory, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of another programmable data processing apparatus to generate a machine, so that the instructions executed by the computer or the processor of the another programmable data processing apparatus generate an apparatus for implementing a specific function in one or more processes in the flowcharts and/or in one or more blocks in the block diagrams.

These computer program instructions may also be stored in a computer-readable memory that can direct a computer or other programmable data processing equipment to operate in a particular manner, such that the instructions stored in the computer-readable memory produce a manufactured article including an instruction apparatus. The instruction apparatus implements the function specified in one or more flows of a flowchart and/or one or more blocks of a block diagram.

These computer program instructions may alternatively be loaded into the computer or the another programmable data processing device, to make a series of operation steps performed on the computer or the another programmable device to generate processing implemented by the computer, and therefore, the instructions performed on the computer or the another programmable device provide steps for implementing specified functions in one or more processes of the flowcharts and/or one or more blocks of the block diagrams.

A person of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The storage medium may be a magnetic disk, an optical disc, a read-only memory (ROM), a random access memory (RAM), or the like.

The foregoing descriptions are merely preferred embodiments of the present invention, but are not intended to limit the present invention. A person skilled in the art may make various alterations and variations to the present invention. Any modification, equivalent replacement, or improvement made and the like within the spirit and principle of the present invention shall fall within the protection scope of the present invention.

What is claimed is:

1. A method for high-speed transient thermal simulation of an electronic device, comprising the following process:
acquiring parameter data of the electronic device;
according to the acquired parameter data, calculating a dynamic weak balance relationship among a heat generation amount, an internal energy increment and a heat dissipation amount of the electronic device so as to obtain a functional relationship between an operating temperature and time of the electronic device;
based on the obtained functional relationship between the operating temperature and time of the electronic device, obtaining a trough temperature value of a transient temperature curve of the electronic device in a weak balance state by a limit solving algorithm;
based on the trough temperature value, setting an initial temperature in a manner of loading a fixed-temperature heat source, and performing simulating calculation for a first preset number of cycles to obtain an initial temperature field; and
based on the initial temperature field, obtaining a high-speed transient temperature change of the electronic device by the operation of a second preset number of pulse stress cycles, wherein
the functional relationship between the temperature T and the time t of the electronic device is as follows:
$$T = {T}_{0} + \frac{{Σ}_{i} {P}_{i} {D}_{i} t}{{Σ}_{i} {C}_{i} {ρ}_{i} {V}_{i} + {Σ}_{i} {h}_{i} {A}_{i} t}$$
wherein Pᵢ is power of each element, Dᵢ is a duty ratio of a power pulse period of each element, Cᵢ is a constant-pressure specific heat capacity of each element, ρᵢ is a density of each element, and Vᵢ is a volume of each element; and T is a temperature of the device at time t, T₀ is an ambient temperature, hᵢ is a convective heat exchange coefficient between each element and air, and Aᵢ is a convective heat exchange area between each element and air.

2. The method for high-speed transient thermal simulation of an electronic device according to claim 1, wherein
the trough temperature value is as follows:
$$\overline{T} = {T}_{0} + {lim}_{t \to ∞} \frac{{Σ}_{í} {P}_{i} {D}_{i} t}{{Σ}_{i} {C}_{i} {ρ}_{i} {V}_{i} + {Σ}_{i} {h}_{i} {A}_{i} t} = {T}_{0} + \frac{{Σ}_{i} {P}_{i} {D}_{i}}{{Σ}_{i} {h}_{i} {A}_{i}}$$

3. The method for high-speed transient thermal simulation of an electronic device according to claim 1, wherein
before setting an initial temperature in a manner of loading a fixed-temperature heat source, a physical structure model of the device is constructed and relevant material parameters are set, the relevant material parameters comprising: density, constant-pressure specific heat capacity and thermal conductivity.

4. The method for high-speed transient thermal simulation of an electronic device according to claim 1, wherein
the dynamic weak balance relationship among the heat generation amount, the internal energy increment and the heat dissipation amount of the electronic device is as follows:
Q_{heat generation amount}=U_{internal energy}+H_{heat dissipation amount}
wherein Q_{heat generation amount} is total Joule heat generated by each element in the device, U_{internal energy} is an internal energy change amount of each element in the device, and H_{heat dissipation amount} is a total convective heat exchange amount between each element and air.

5. The method for high-speed transient thermal simulation of an electronic device according to claim 4, wherein
Q_{heat generation amount}=ΣᵢPᵢDᵢt
wherein Pᵢ is the power of each element, and Dᵢ is the duty ratio of the power pulse period of each element.

6. The method for high-speed transient thermal simulation of an electronic device according to claim 4, wherein
U_{internal energy}=ΣᵢCᵢρᵢVᵢ(T−T₀)
wherein Cᵢ is the constant-pressure specific heat capacity of each element, ρᵢ is the density of each element, Vᵢ is the volume of each element, T is the temperature of the device at time t, and T₀ is the ambient temperature.

7. The method for high-speed transient thermal simulation of an electronic device according to claim 4, wherein
H_{heat dissipation amount}=ΣᵢhᵢAᵢ(T−T₀)t
wherein hᵢ is the convective heat exchange coefficient between each element and air, Aᵢ is the convective heat exchange area between each element and air, T is the temperature of the device at time t, and T₀ is the ambient temperature.

8. A system for high-speed transient thermal simulation of an electronic device, comprising;
a data acquiring module, configured to acquire parameter data of the electronic device;
a temperature and time relationship acquiring module, configured to, according to the acquired parameter data, calculate a dynamic weak balance relationship among a heat generation amount, an internal energy increment and a heat dissipation amount of the electronic device so as to obtain a functional relationship between an operating temperature and time of the electronic device;
a trough temperature acquiring module, configured to, based on the obtained functional relationship between the operating temperature and time of the electronic device, obtain a trough temperature value of a transient temperature curve of the electronic device in a weak balance state by a limit solving algorithm;
an initial temperature field generating module, configured to, based on the trough temperature value, set an initial temperature in a manner of loading a fixed-temperature heat source, and performing simulating calculation for a first preset number of cycles to obtain an initial temperature field; and
a high-speed transient temperature change simulation result generating module, configured to, based on the initial temperature field, obtain a high-speed transient temperature change of the electronic device by the operation of a second preset number of pulse stress cycles; wherein,
the functional relationship between the temperature T and the time t of the electronic device is as follows:
$$T = {T}_{0} + \frac{{Σ}_{i} {P}_{i} {D}_{i} t}{{Σ}_{i} {C}_{i} {ρ}_{i} {V}_{i} + {Σ}_{i} {h}_{i} {A}_{i} t}$$
wherein Pᵢ is power of each element, Dᵢ is a duty ratio of a power pulse period of each element, Cᵢ is a constant-pressure specific heat capacity of each element, ρᵢ is a density of each element, and Vᵢ is a volume of each element; and T is a temperature of the device at time t, T₀ is an ambient temperature, hᵢ is a convective heat exchange coefficient between each element and air, and Aᵢ is a convective heat exchange area between each element and air.

9. The system for high-speed transient thermal simulation of an electronic device according to claim 8, wherein
the trough temperature value is as follows:
$$\overline{T} = {T}_{0} + {lim}_{t \to ∞} \frac{{Σ}_{i} {P}_{i} {D}_{i} t}{{Σ}_{i} {C}_{i} {ρ}_{i} {V}_{i} + {Σ}_{i} {h}_{i} {A}_{i} t} = {T}_{0} + \frac{{Σ}_{i} {P}_{i} {D}_{i}}{{Σ}_{i} {h}_{i} {A}_{i}}$$
wherein Pᵢ is power of each element, Dᵢ is a duty ratio of a power pulse period of each element, Cᵢ is a constant-pressure specific heat capacity of each element, ρᵢ is a density of each element, and Vᵢ is a volume of each element; and T is a temperature of the device at time t, T₀ is an ambient temperature, hᵢ is a convective heat exchange coefficient between each element and air, and Aᵢ is a convective heat exchange area between each element and air.
